(19) United States
(12) Patent Application Publication
(10) Pub. No.: US 2015/0154690 A1
(43) Pub. Date: Jun. 4, 2015

(54) INTERACTIVE ELECTRONIC MENU, ORDERING, MONITORING AND PAYMENT SYSTEM AND METHOD THEREFOR

(71) Applicant: CHUL PARK, TEMPE, AZ (US)

(72) Inventor: CHUL PARK, TEMPE, AZ (US)

(21) Appl. No.: 14/095,791

(22) Filed: Dec. 3, 2013

(51) Int. Cl. G06Q 30/06; G06Q 30/02

(52) U.S. Cl. CPC G06Q 30/0643; G06Q 30/0241

(57) ABSTRACT

An electronic menu has a plurality of display devices, an input device, at least one microprocessor coupled to the plurality of displays and the input device and a memory operatively coupled to the processor, the memory storing program instructions. The program instructions when executed by the processor, causes the processor to: displaying a plurality of language icons on one of the display devices; translating text on the plurality of displays to a language associated with a selected one of the plurality of language icons; display an interactive advertisement on one of the display devices; and rewarding a user of the electronic menu when the user enters data in response to the interactive advertisement.

### RELATED APPLICATIONS

This patent application is related to U.S. Provisional Application No. 61/732,740, filed Dec. 3, 2013, entitled“INTERACTIVE ELECTRONIC MENU” in the name of Chul Park, and which is incorporated herein by reference in its entirety. The present patent application claims the benefit under 35 U.S.C. §119(e).

### TECHNICAL FIELD

This invention relates generally to a restaurant menu, and, more particularly, to an interactive electronic menu to allow a customer to review food items and the ingredients, change ingredients on a food item; monitor the status of the customer's order; make a payment; provide feedback to the restaurant; provide a source of entertainment while waiting for an order and other features.

### BACKGROUND

In many sit down restaurants or other sit down location where food ordering occurs, ordering food or other items is a fairly simple matter. A customer is generally taken to a table/booth by a restaurant employee. Once the customer has taken a seat, the restaurant employee may give the customer a menu.

In most cases, the menu may be a paper sheet listing different food items and/or drinks (hereinafter food items) which the customer may order along with pricing for the food items. Some menus may further include a description of the food item and how the food item may be prepared. Recently, as people are becoming more health conscious, some restaurants have included nutritional information about the food item on the menu. For example, under different food items listed on the menu, nutritional information such as the calories, grams of fat, grams of sodium, grams of protein, etc may be listed. Unfortunately, the amount of information about the food item on a paper menu is limited due to the amount of space on the paper menu.

Recently, some restaurants have implemented the use of electronic menus. The electronic menus may allow a customer to have additional information about the food item as the customer is not limited to a single printed page. However, presently, electronic menus are only used to show information about the food item and serve no other purpose.

Therefore, it would be desirable to provide a device and method that overcomes the above problems.

### SUMMARY

An electronic menu has a plurality of display devices, an input device, at least one microprocessor coupled to the plurality of displays and the input device and a memory operatively coupled to the processor, the memory storing program instructions. The program instructions when executed by the processor, causes the processor to: displaying a plurality of language icons on one of the display devices; translating text on the plurality of displays to a language associated with a selected one of the plurality of language icons; display an interactive advertisement on one of the display devices; and rewarding a user of the electronic menu when the user enters data in response to the interactive advertisement.

An electronic menu has a plurality of display devices, an input device, at least one microprocessor coupled to the plurality of displays and the input device and a memory operatively coupled to the processor, the memory storing program instructions. The program instructions when executed by the processor, causes the processor to: displaying a plurality of language icons on one of the display devices; translating text on the plurality of displays to a language associated with a selected one of the plurality of language icons; display an interactive advertisement on one of the display devices; rewarding a user of the electronic menu when the user enters data in response to the interactive advertisement; display a plurality of photos, wherein each photo represents an individual item sold on the electronic menu; displaying ingredients associated with one of the individual items sold associated with a selected one of the plurality of photos, wherein the user can remove ingredients associated with the individual items sold associated with the selected one of the plurality of photos; and displaying nutritional information associated with the individual items sold associated with the selected one of the plurality of photos.

An electronic menu has a foldable cover, a plurality of display devices, wherein a first display is placed on one side of the cover and a second display is placed on a second side of the cover, an input device, at least one microprocessor coupled to the plurality of displays and the input device, a memory operatively coupled to the processor, the memory storing program instructions that when executed by the processor, causes the processor to: displaying a plurality of language icons on one of the display devices; translating text on the plurality of displays to a language associated with a selected one of the plurality of language icons; display an interactive advertisement on one of the display devices; rewarding a user of the electronic menu when the user enters data in response to the interactive advertisement; display a plurality of photos, wherein each photo represents an individual item sold on the electronic menu; displaying ingredients associated with one of the individual items sold associated with a selected one of the plurality of photos, wherein the user can remove ingredients associated with the individual items sold associated with the selected one of the plurality of photos; and displaying nutritional information associated with the individual items sold associated with the selected one of the plurality of photos.

The foregoing and other objects, features, and advantages of the invention will be apparent from the following, more particular, description of the preferred embodiments of the invention, as illustrated in the accompanying drawings.

### BRIEF DESCRIPTION OF DRAWINGS

The novel features believed to be characteristic of the application are set forth in the appended claims. In the descriptions that follow, like parts are marked throughout the specification and drawings with the same numerals. The drawing figures are not necessarily drawn to scale and certain figures can be shown in exaggerated or generalized form in the interest of clarity and conciseness. The application itself, however, as well as a preferred mode e, further objectives and advantages thereof, will be best understood by reference to the following detailed description of illustrative embodiments when read in conjunction with the accompanying drawings:

FIG. 1 is a simplified block diagram of the tem of the present invention;

FIG. 2 is a simplified block diagram of components of the electronic menu;

FIG. 3 is a front view of the electronic menu;

FIG. 4 is a front view of the electronic menu showing an advertisement screen and a language selection screen;

FIG. 5 is a front view of the electronic menu showing an appetizer screen;

FIG. 6 shows a magnified screen shot of an information page for an item selected on the electronic menu;

FIG. 7 is a front view of the electronic menu showing a checkout screen; and

FIG. 8 is a front view of the electronic menu showing a status screen.

### DESCRIPTION OF THE APPLICATION

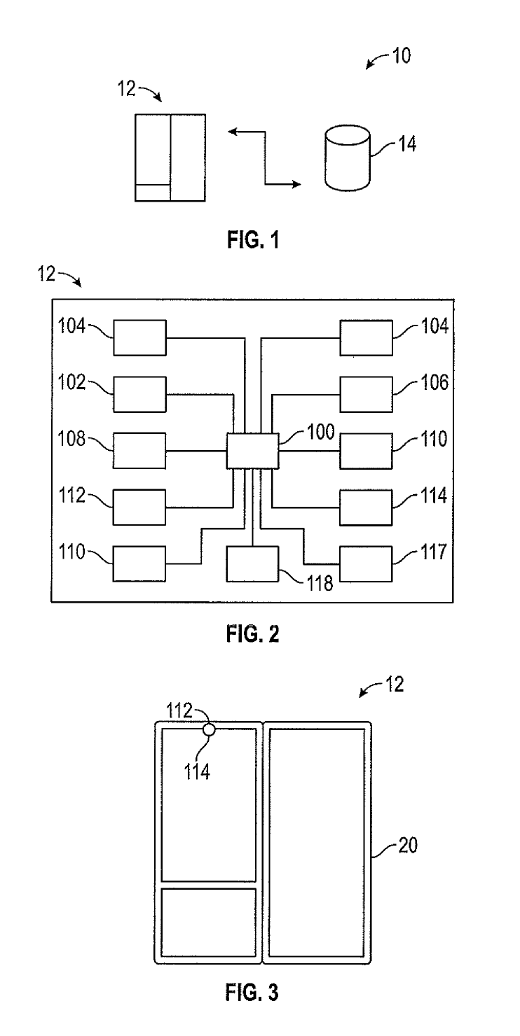

Referring to FIG. 1, an electronic menu system 10 is shown. The electronic menu system 10 may have a wireless electronic menu 12 (hereinafter electronic menu 12). The electronic menu 12 may communicate with a server 14. Data may be transferred to and from the electronic menu 12 and the server 14. The data may be transferred to and from the server in a wireless manner.

Referring to FIG. 2, a block diagram schematically showing the circuit design of one embodiment of the electronic menu 12 is shown. The electronic menu 12 may have a microprocessor 100. Memory 102 may be coupled to the microprocessor 100. A display device 104 may be coupled to the microprocessor 100 for displaying information. Input device 106 may be coupled to the microprocessor 100 for entering data to the electronic menu 10. In accordance with one embodiment the display device 104 may be a touch screen display device thereby allowing the display device 104 to function as an input device. One or more speakers 108 may be coupled to the microprocessor 100 for outputting audio signals. A microphone 110 may be coupled to the microprocessor 100 for transforming audio signals to be transmitted by the electronic menu 12. A camera 112 may also be coupled to the microprocessor 100. The camera 112 may be a video camera, a still camera or the like. One or more sensors 114 may further be coupled to the microprocessor 100. The sensors 114 may be used to monitor light conditions to adjust the brightness of the display device 104, adjust the focus of the camera 112 and the like. Other sensors 114 may be located on the electronic menu 12 without departing from the spirit and scope of the present invention. A wireless transceiver 116 may be coupled to the microprocessor 100 to allow bidirectional wireless communication between the electronic menu 12 and the server 14. A card reading device 117 may be coupled to the microprocessor 100. The card reading device 117 may be used to read credit card information entered by the customer. The card reading device may be a magnetic strip card reader or the like.

A power supply 118 may be provided to power the components of the electronic menu 12 in accordance with one embodiment, the power supply 118 may be a rechargeable battery. However, the above listing is given as an example and should not be seen in a limiting manner. Other types of power supplies may be used without departing from the spirit and scope of the present invention.

Referring now to FIG. 3, the electronic menu 12 is positioned within a menu folder 20. The menu folder 20 may be used to allow the electronic menu 10 to look more like a traditional menu. The menu folder 20 may further be used to protect the electronic menu 12 and to prevent dust, water, or other items from damaging the electronic menu 12. The menu folder 20 may further act as a power saving device. When the menu folder 20 is folded over (i.e., closing the electronic menu 12), the sensors 114 will place the one or more display devices 104 in sleep mode to conserve power.

As shown in FIG. 3, the camera 112 may be mounted on a top section of the electronic menu 12. As stated above, the camera 112 may be used to take video or still images. A customer may use the camera 112 to take videos/still pictures of the restaurant, food, the customer, people with the customer, and the like. The videos/still pictures may be saved to the memory 102 (FIG. 2). Thus, customers may then upload the videos/still pictures to a social network website like Facebook, Flickr, Instagram, Yelp, and the like. The customer may further send the videos/still pictures to the customer, family, friends and the like. In accordance with one embodiment, the customer may send the videos/still pictures via email. The camera 112 may further be used for video chatting. The customer may use the camera 112 to video chat with other individuals who owns a video capable smart phone, tablet or computer or the customer may know or even with other customers in the restaurant who also may be using one of the electronic menus 12.

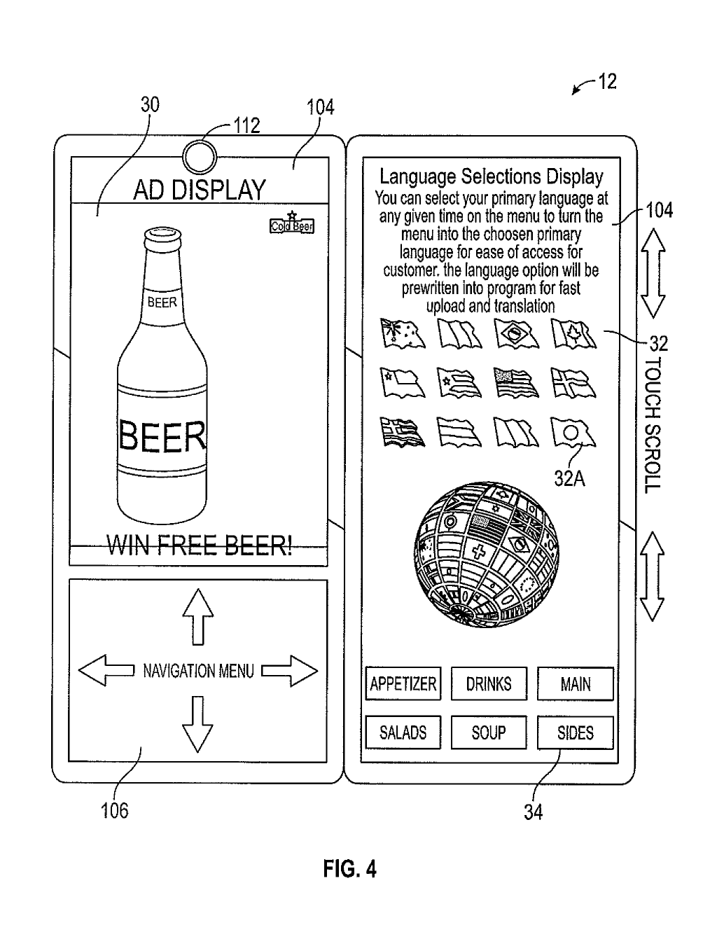

Referring now to FIG. 4, when a customer opens the electronic menu 12, a pair of display devices 104 may be seen. The display device 104 may be a flexible display device. An input device 106 may be positioned in the electronic menu 12. The input device 106 may be part of one of the display devices 104 (i.e., touch screen) or a separate device such as keys, buttons or the like. The above is given as examples of different input devices 104 and should not be seen in a limiting scope.

In accordance with one embodiment, the electronic menu 12 may be programmed to perform a plurality of functions. The electronic menu 12 may be designed to execute program instructions through the microprocessor 100 and memory 102 of the electronic menu 12. Alternatively, the electronic menu 12 may be designed to download content to display from the server 14.

The electronic menu 12 may be programmed or to download content from the server 12 so that one of the display devices 104 may be used to show an advertisement page 30. The advertisement page 30 may be for a product sold in the establishment or not. For example, the advertisement may be for a beverage that is sold in the establishment. Alternatively, the advertisement may be for another restaurant associated with the current establishment. The above are given as examples and should not be seen in a limiting manner.

The advertisement page 30 may be a still picture, a video or the like. The advertisement may even be interactive. For example, the advertisement page 30 may be an interactive questionnaire wherein the customer would answer questions about the product being advertised. The customer may even be rewarded with a free sample or a discount on the product for participating.

The electronic menu 12 may be programmed or to download content from the server 12 so that one of the display devices 104 may be used to show a language selection page 32. The language selection page 32 may show a plurality of different languages in which text on the electronics menu 10 may be translated. The language selection page 32 may have a plurality of icons 32A. Each icon 32A may represent a specific language in which the electronic menu 12 may be translated. In the present embodiment, the icons 32A may be seen as flags. However, this is just shown as an example and should not be seen in a limiting manner.

The text on the electronic menu 12 may be translated in several manners. For example, the microprocessor 100 may be programmed to translate the text in the electronic menu 12. Alternatively, the server 14 may be used to translate any text and transmit the text to the electronic menu 12. In accordance with another embodiment, the server 14 may be used to input all data to the electronic menu 12. The server 14 may have a translation programmed stored within that may be used to translate all text entered into the server 14. The server 14 may then load all text and translated text into the electronic menu 12. In accordance with one embodiment, the text and translated text may be stored in the memory 102. By selecting a desired icon 32A, the processor 100 may be used to load the proper language of the text to be displayed.

The electronic menu 10 may have a content icon 34. The content icon 34 may list the different sections of the electronic menu 12. For example, in the present embodiment, content icons may include, but is not limited to, appetizers, drinks, main entrees, salads, soups, sides, etc. The above listing is given as an example and should not be seen in a limiting manner. Other content icons 34 may be used to direct the electronic menu 12 to a specified page.

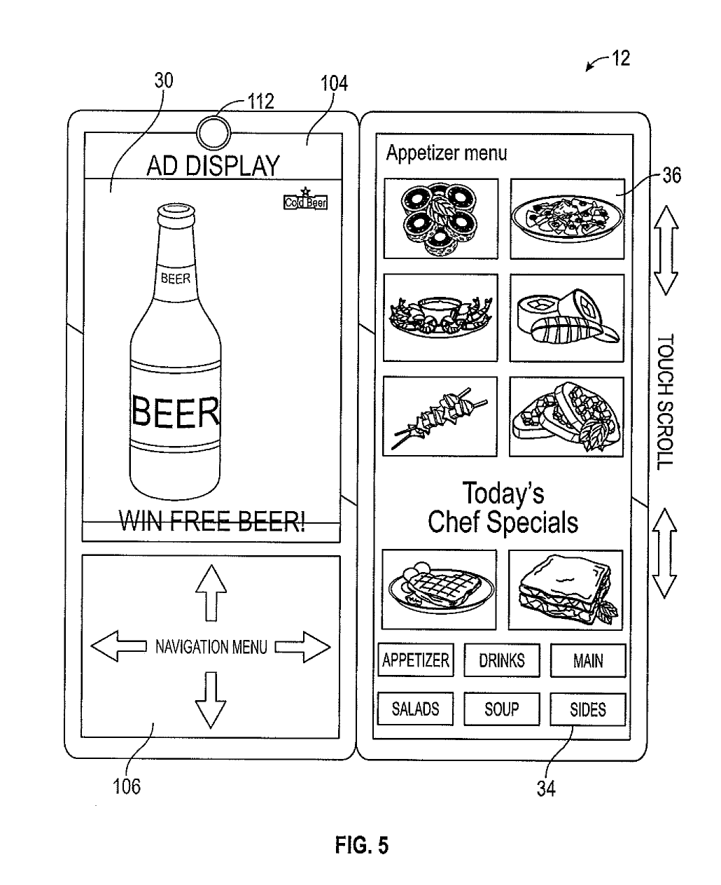

Once a content icon 34 is selected, the electronic menu 12 may display a specific page associated with the selected content icon 34. Pictures 36 associated with the selected icon 34 may be displayed. For example, as shown in FIG. 5, if a customer selects Appetizers, pictures 36 of the different appetizers available may be displayed. The pictures 36 may include a standard list of appetizers as well as special appetizers of the day. While 8 different pictures 36 may be shown in FIG. 5, this is only shown as an example and more or less pictures may be displayed without departing from the spirit and scope of the present invention.

The customer may use the input device 106 to scroll through the different pictures 36 on one or more pages. The input device 106 may be used to highlight a specific appetizer. Further, the electronic menu 12 may be programmed to touch scroll through the pictures/pages on the electronic menu 12 and the customer may touch a specific picture 36.

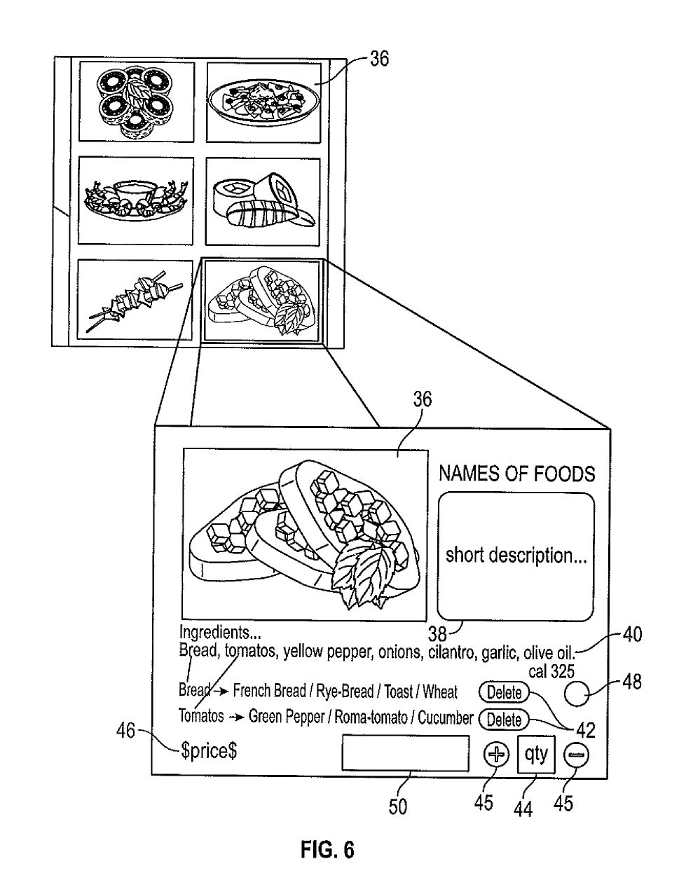

As shown in FIG. 6, once a pictures 36 is selected, information related to the selected picture 36 (i.e., appetizer) may be displayed. As shown in FIG. 6, an area 38 may be used to provide a short description of the item selected. Another area 40 may be used to list the different ingredients as well as nutritional information such as fat content, calories, and the like.

An area 42 may be provided that allows the customer to add/remove certain ingredients. Thus, customers, especially those with food allergies, may be able to change, substitute and or remove ingredients so that the customer may have an ease of mind when ordering the item knowing that the item may be prepared to his/her liking. In accordance with one embodiment, to simplify the process area 42 may have selected substitutions for selected ingredients. For example, as shown in FIG. 6, the customer may select a desired bread type or delete brad all together. They customer may also change tomatoes to a preselected substitute such as green peppers, Roma tomatoes, cucumbers, or the like. The above is given as an example and should not be seen in a limiting manner. Some ingredients may just have the option to add/remove, while other ingredients may have pre-defined substitutes. A user may further have an option of inputting an ingredient not listed.

An input area 44 may be provided to allow the customer to enter in a quantity of the item the customer would like to order. As shown in FIG. 6, the area 44 may have input devices 45 to add/substrate the desired amount.

An area 46 may be provided to show a price of the item. The area 46 may be dynamic such that as when the customer enters the quantity of the item requested, the area 46 is updated with the new price. For example, if the price for an item is $5.00, if the customer orders 5 servings, the area 46 would be updated to display $25.00.

After the item has been selected, the ingredients chosen, and the serving entered, the customer may select the add button 48 to enter the item order. An input area 50 may be provided to enter a name so that the item selected is saved under a particular customer name. The input device 106 may be used to enter the particular customer name. The option to enter particular customer name for the item selected allows a party to separate check for each party member. It further allows a server to determine which items belong to specific customers.

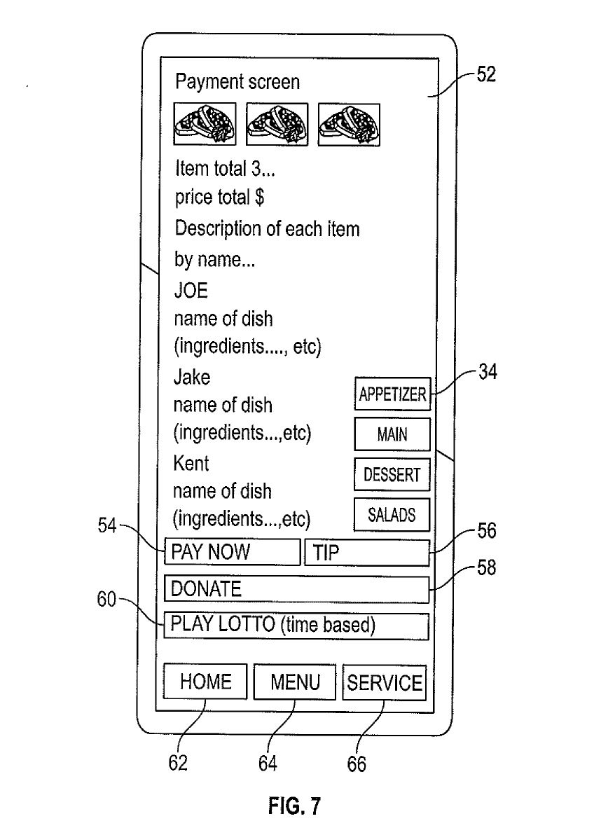

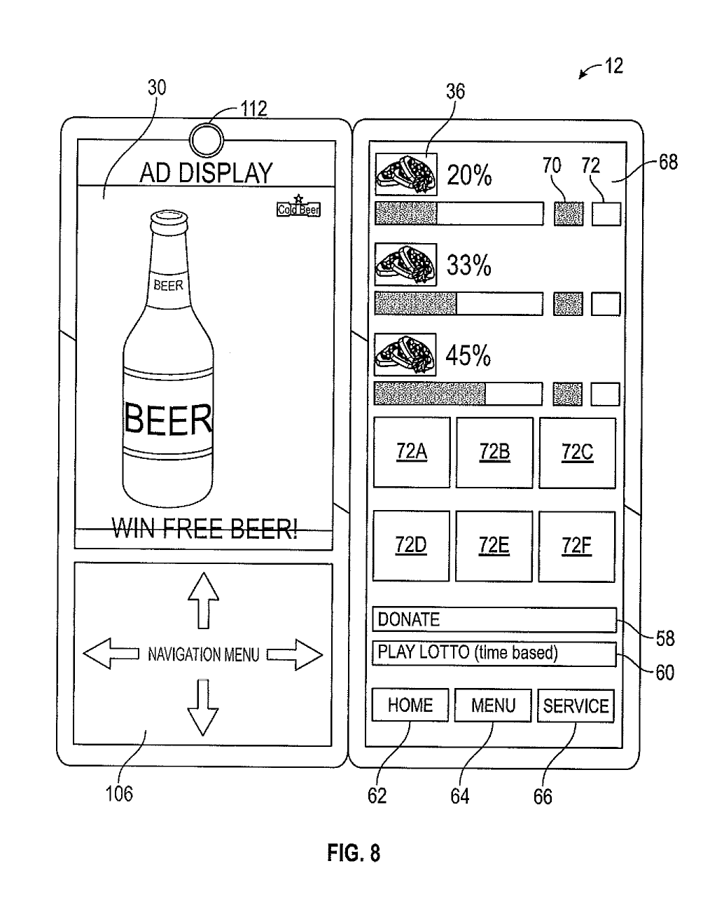

Once all items have been selected by each customer, the electronic menu 12 will display a checkout display 52 as shown in FIG. 7. The checkout display 52 allows the customer/party to review the order. The items are still editable and the customer may still add/delete and or alter the item ordered.

Once the order has been verified by the customer/party, the checkout display 52 may allow a user to pay by selecting a PAY NOW area 54 on the checkout display 52. By pressing the PAY NOW area 54 the total amount may be calculated. The customer may then use the card reading device 117 (FIG. 2) to pay the bill. Alternatively, the user may use the input device 106 to enter payment information (i.e., credit card, debit card, bank account #, and the like). A TIP area 56 may be provided. The TIP area 56 may allow the customer include a tip when calculating the bill. The TIP area 56 may be designed to have a preset amount included in the calculations, for example 15%. Alternatively, the TIP area 56 may be designed to allow the user to enter a desired tip amount by using the input device 106.

The checkout display 52 may provide a plurality other features. The checkout display 52 may provide a DONATE area 58. The DONATE area 58 may be used to allow a customer/party to donate to a particular charity. The charity may be a preselected charity determined by the restaurant. Alternatively, the customer may select a desired charity by using the input device 106. The customer/party may select a predefined amount or enter an amount and then use the card reading device 117 to finalize the donation.

The checkout display 52 may provide a lottery area 60. The lottery area 60 may allow the customer to purchase lottery tickets or the like. The customer may use the input device 106 to enter desired numbers to play and the card reading device 117 to finalize the transaction.

The checkout display 52 may further have a HOME area 62, a MENU area 64 and or a SERVICE area 66. The HOME area 62 may be used to take the customer back to the home page of the electronic menu 12. The MENU area 64 may be used to take the customer back to the main menu page of the electronic menu 12. The SERVICE area 66 may be used to page the waiter/server.

After the payment has been made, or alternatively, after the order has been finalized, the electronic menu 12 may display a status screen 68. The status screen 68 may show the status of the food being prepared by the cooks in the kitchen. The status screen 68 shows the item ordered by way of a picture 36 and the current preparation status. The status screen 68 shows that the food is being prepared by the ways of means of percentage, percentage bar graphs, text, pictures or the like to show the status. Customer may use change icons 70 and 72 to make last minute changes or cancel the order, but within a predefined time range established since each food takes time to prep. If the customer decides to make changes, the order will all be paused or the single item and be prepared at a later time upon completion of the changes that the customer has made. The electronic menu 12 may be able to determine the given allowed time to make sure that no dish is allowed for any change if the order is past a strict time frame.

A plurality of entertainment icons 72A-72F may be provided on the electronic menu 12. While the entertainment icons 72A-72F are shown on the status screen 68, this is only shown as an example. The entertainment icons 72A-72F may be place on different screens without departing from the spirit and cop of the present invention. The entertainment icons 72A-72F may include icons that connect the electronic menu to the internet; take photographs/videos using the camera 112; upload and send the photographs/videos; provide a video chat connection to chat with other individuals who owns a video capable smart phone, tablet or computer or the customer may know or even with other customers in the restaurant who also may be using one of the electronic menus 12; provide a link to enter a review of the restaurant on a social networking website such as Yelp, Urbanspoon, Zagat and the like; as well as other features.

While the invention has been particularly shown and described with reference to preferred embodiments thereof, it will be understood by those skilled in the art that the foregoing and other charges in form and details may be made therein without departing from the spirit and scope of the invention.

What is claimed is:

1. An electronic menu comprising:
a plurality of display devices;
an input device;
at least one microprocessor coupled to the plurality of displays and the input device;
a memory operatively coupled to the processor, the memory storing program instructions that when executed by the processor, causes the processor to:
displaying a plurality of language icons on one of the display devices;
translating text on the plurality of displays to a language associated with a selected one of the plurality of language icons;
display an interactive advertisement on one of the display devices; and
rewarding a user of the electronic menu when the user enters data in response to the interactive advertisement.

2. The electronic menu of claim 1, wherein the program instructions executed by the processor, causes the processor to:
display a plurality of photos, wherein each photo represents an individual item sold on the electronic menu;
displaying ingredients associated with one of the individual items sold associated with a selected one of the plurality of photos; and
displaying nutritional information associated with the individual items sold associated with the selected one of the plurality of photos.

3. The electronic menu of claim 2, wherein the program instructions executed by the processor, causes the processor to allow the user to remove ingredients associated with the individual items sold associated with the selected one of the plurality of photos.

4. The electronic menu of claim 2, wherein the program instructions executed by the processor, causes the processor to displays alternative ingredients for the user to select.

5. The electronic menu of claim 1, wherein the program instructions executed by the processor, causes the processor to:
total a currency amount of all items selected; and
accept payment information entered by the user.

6. The electronic menu of claim 1, wherein the program instructions executed by the processor, causes the processor to display a status of an order on one of the video displays.

6. The electronic menu of claim 1, wherein the program instructions executed by the processor, causes the processor to upload at least one of photos or a video taken by the electronic menu.

7. The electronic menu of claim 1, wherein the program instructions executed by the processor, causes the processor to uploading photos taken by the electronic menu to a selected social networking website.

8. The electronic menu of claim 1, wherein the program instructions executed by the processor, causes the processor to establish a connection to a website for participating in one of a bingo game or lottery.

9. An electronic menu comprising:
a plurality of display devices;
an input device;
at least one microprocessor coupled to the plurality of displays and the input device;
a memory operatively coupled to the processor, the memory storing program instructions that when executed by the processor, causes the processor to:
displaying a plurality of language icons on one of the display devices;
translating text on the plurality of displays to a language associated with a selected one of the plurality of language icons;
display an interactive advertisement on one of the display devices;
rewarding a user of the electronic menu when the user enters data in response to the interactive advertisement;
display a plurality of photos, wherein each photo represents an individual item sold on the electronic menu;
displaying ingredients associated with one of the individual items sold associated with a selected one of the plurality of photos, wherein the user can remove ingredients associated with the individual items sold associated with the selected one of the plurality of photos; and
displaying nutritional information associated with the individual items sold associated with the selected one of the plurality of photos.

10. The electronic menu of claim 9, wherein the program instructions executed by the processor, causes the processor to displays alternative ingredients for the user to select for the individual items sold associated with the selected one of the plurality of photos.

11. The electronic menu of claim 10, wherein the program instructions executed by the processor, causes the processor to:
total a currency amount of all items selected; and
accept payment information entered by the user.

12. The electronic menu of claim 11, wherein the program instructions executed by the processor, causes the processor to display a status of an order on one of the video displays.

13. The electronic menu of claim 10, wherein the program instructions executed by the processor, causes the processor to upload at least one of photos or a video taken by the electronic menu.

14. The electronic menu of claim 10, wherein the program instructions executed by the processor, causes the processor to uploading photos taken by the electronic menu to a selected social networking website.

15. The electronic menu of claim 10, wherein the program instructions executed by the processor, causes the processor to establish a connection to a website for participating in one of a bingo game or lottery.

16. An electronic menu comprising:
a foldable cover;
a plurality of display devices, wherein a first display is placed on one side of the cover and a second display is placed on a second side of the cover;
an input device;
at least one microprocessor coupled to the plurality of displays and the input device;
a memory operatively coupled to the processor, the memory storing program instructions that when executed by the processor, causes the processor to:
displaying a plurality of language icons on one of the display devices;
translating text on the plurality of displays to a language associated with a selected one of the plurality of language icons;
display an interactive advertisement on one of the display devices;
rewarding a user of the electronic menu when the user enters data in response to the interactive advertisement;
display a plurality of photos, wherein each photo represents an individual item sold on the electronic menu;
displaying ingredients associated with one of the individual items sold associated with a selected one of the plurality of photos, wherein the user can remove ingredients associated with the individual items sold associated with the selected one of the plurality of photos; and
displaying nutritional information associated with the individual items sold associated with the selected one of the plurality of photos.

17. The electronic menu of claim 16, wherein the program instructions executed by the processor, causes the processor to displays alternative ingredients for the user to select for the individual items sold associated with the selected one of the plurality of photos.

18. The electronic menu of claim 16, wherein the program instructions executed by the processor, causes the processor to:
total a currency amount of all items selected; and
accept payment information entered by the user.

19. The electronic menu of claim 16, wherein the program instructions executed by the processor, causes the processor to display a status of an order on one of the video displays.

20. The electronic menu of claim 16, wherein the program instructions executed by the processor, causes the processor to uploading photos taken by the electronic menu to a selected social networking website.
